(19) United States
(12) Patent Application Publication
(10) Pub. No.: US 2006/0272472 A1
(43) Pub. Date: Dec. 7, 2006

(54) Apparatus for learning to play a stringed instrument

(76) Inventors: Richard Lacelle, Gatineau (CA); Troy Cray, Ottawa (CA); Pierre Charron, Lapeche Wakefield (CA)

Correspondence Address: MIKE GAUTHIER DEVIAT, 355 GOODWILL DRIVE, BOX 400, GARSON, ON, P3L 1S7, CA

(21) Appl. No.: 11/445,384

(22) Filed: Jun. 2, 2006

(30) Foreign Application Priority Data
Jun. 2, 2005 (CA) 2,508,373

(51) Int. Cl. G10D 3/06; G10D 3/04; G10D 1/08

(52) U.S. Cl. 84/314 R

(57) ABSTRACT

A method and apparatus for learning to play a stringed musical instrument comprising a modified stringed instrument neck wherein a slot beneath a transparent fingerboard allows the insertion of one of a plurality of pre-printed learning templates whereby inserting said template allows the player to see printed markings—such as chord patterns or scales—through the transparent fingerboard. Templates can be designed for novice to avid players. Use of the present invention allows rudimentary and auditory skill acquisition of stringed musical instruments.

### FIELD OF THE INVENTION

The present invention relates to a method and apparatus for learning to play a stringed musical instrument. The invention comprises a modified stringed instrument neck wherein a slot beneath a transparent fingerboard allows the insertion of one of a plurality of pre-printed learning templates whereby inserting said template allows the player to see printed markings—such as chord patterns or scales—through the transparent fingerboard. Templates can be designed for novice to avid players. Use of the present invention allows rudimentary and auditory skill acquisition of stringed musical instruments.

### BACKGROUND OF THE INVENTION

To some, learning to play a musical instrument—namely stringed instruments—can be a daunting and lengthy undertaking. Many books and other implements have been developed over the years to help those would-be players achieve such a goal. However, none to date have enabled players to follow fingering patterns while playing, and maintain the “feel” that the instrument has been known to have.

The applicants have indeed crossed that threshold in developing the first in such learning tools.

Through the inventive process, the applicants needed to ensure that by modifying a stringed instrument's fingerboard, the feel would not be lost, ensure that the patterns could be pro-ratable to varied skill levels, ensure the templates are easy to interchange, and had to compensate for an offset in the player's viewing angle while looking downwardly at the instrument.

What was achieved was a series of pre-printed and blank templates designed to insert into a plurality of slots in the neck of a modified stringed instrument, along with a transparent fingerboard, which also incorporate this instrument's frets. In doing so, the feel is maintained, templates can be easily interchanged, and the angle of view created by the transparent fingerboard's thickness is compensated for.

The applicant is aware of attempts in prior art to provide means providing patterns on real or artificial guitar-type necks.

An example may be had by referring to prior art U.S. Pat. No. 3,785,240 of Hill, issued Jan. 15, 1974 depicting a device for teaching chords for a stringed instrument including a stringboard having strings and frets. The device includes an elongate box having a front stringboard wall. A plurality of parallel rows extend longitudinally on the front stringboard wall, the rows representing the strings of the instrument. A plurality of parallel rows extend transversely of the string rows and represent frets of the instrument. A plurality of apertures are provided in regularly spaced, longitudinal alignment along each string row, and in regularly spaced, transverse alignment relative to the string rows. The elongate box further includes a card-supporting wall behind and spaced from the front stringboard wall to provide a slot behind the apertures. A chord card fits in the slot. This card includes a designation of a chord and a fret, an index for alignment with a fret row, and a designation of fingers located for alignment with appropriate apertures when the index is aligned with a fret row to indicate visually through the apertures the finger placement on the strings of the instrument.

Another example of prior art may be had in referring to U.S. Pat. No. 5,920,023 of Ravagni, issued Jul. 6, 1999, which depicts a device for teaching students of stringed instruments note locations and proper finger placement on the fingerboard of the instrument. The device may be adapted for use with either a fretted or non-fretted instrument. The device comprises a sheet of autogenously adhesive plastic, such as cling vinyl, on which is printed a series of markers indicating note locations, scales or chords. If the device is to be applied to a fretted instrument, the device further has fret openings cut therein, adapted to engage the frets when applied to the instrument. The device is applied to the instrument by inserting it between the strings and the fingerboard, wrapping it around the neck of the instrument and adhering it onto itself along the back of the neck of the instrument.

While many attempts in prior art have been made to provide students of stringed instruments the means to follow chord and scale patterns, none provide this ability while actually playing such patterns and the inherent ease of changing such patterns.

### SUMMARY OF THE INVENTION

It is thus the object of the present invention to provide players with a series of pre-printed and blank templates designed to insert into a plurality of slots in the neck of a modified stringed instrument, along with a transparent fingerboard, which also incorporate this instrument's frets, and in doing so, maintaining the instrument's feel, easily interchangeable templates, and a compensated angle of view created by the transparent fingerboard's thickness.

In one aspect of the invention, the benefits can be applied to existing or new stringed instruments.

In another aspect of the invention, fretless stringed instruments such as cellos, violas and the like can also be adapted to the present invention.

Accordingly, the system of the present invention provides players with pre-printed and blank templates designed to insert into a plurality of slots in the neck of a modified stringed instrument, along with a transparent fingerboard, which also incorporate this instrument's frets, and in doing so, maintaining the instrument's feel, easily interchangeable templates, and a compensated angle of view created by the transparent fingerboard's thickness.

While the invention is embodied in a conventional acoustic guitar, the utility of the invention includes but is not limited to guitars.

### BRIEF DESCRIPTION OF THE DRAWINGS

These and other advantages of the invention will become apparent upon reading the following detailed description and upon referring to the drawings in which:

FIG. 1 is a partial top plan view of an acoustic guitar along with a template of the present invention ready for insertion.

FIG. 2 is a partial top plan view of an acoustic guitar with a semi-inserted template of the present invention.

FIG. 3 is a partial top plan view of an acoustic guitar with a fully inserted template of the present invention.

FIG. 4 is a cross-sectional view taken from FIG. 3 of the neck portion of an acoustic guitar of the present invention.

FIG. 5 is also a cross-sectional view taken from FIG. 3 of the neck portion of an acoustic guitar of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

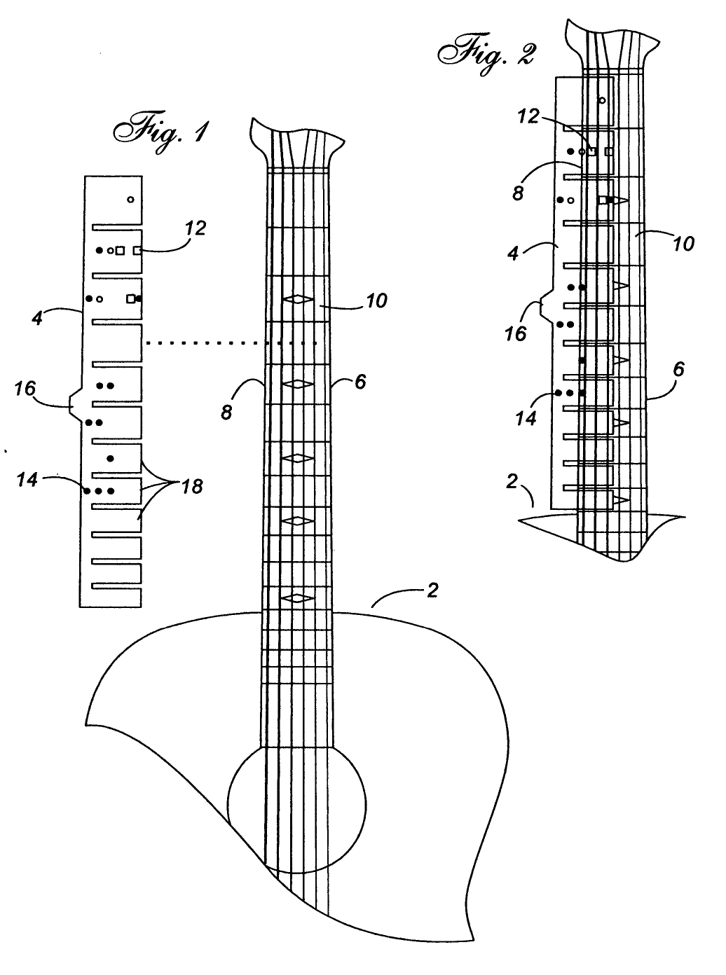

Turning to the drawings, in particular, FIGS. 1, 2 and 3 which illustrate partial top plan views of an acoustic guitar 2 along with a pattern template 4 of the present invention ready for insertion wherein the guitar's neck 6 has been modified either post production or even at production thereof so as to provide a space 8 behind a transparent fingerboard 10 where the pattern template 4 may be inserted. The transparent fingerboard 10 thereby allows full view of the pattern template 4 therebehind. The pattern template 4 is one of a plurality and incorporates either pre-printed chord patterns 12 or scale patterns 14 for easy visualization of said patterns by player. A pull-tab 16 is integral to the pattern templates 4 so as to ease removing said templates 4. The feel and hand conformity of the guitar is unaltered by the implementation of the present invention.

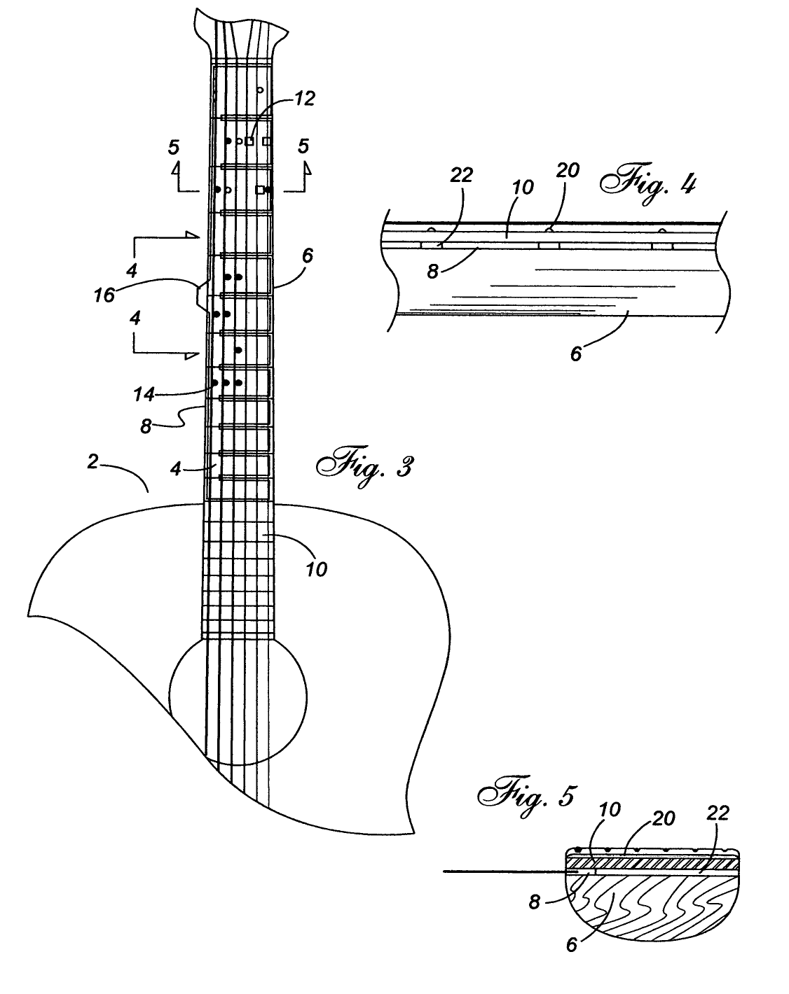

Referring now to FIG. 4, a cross-sectional view taken from FIG. 3 of the neck portion of an acoustic guitar of the present invention wherein the guitar neck 6 is original and the added modified portion includes partial risers 22 integral with the new transparent fingerboard 10 and frets 20 fixedly attached to the top surface of the fingerboard 10 in such a fashion as to maintain semitone intonation between said frets 20. A plurality of slots or spaces 8 is thereby formed between every fret 20 in the common playing area of the guitar 2.

And finally, FIG. 5 also illustrates a cross-sectional view taken from FIG. 3 of the neck portion of an acoustic guitar of the present invention wherein one can see that the riser 22, integrally formed with the fingerboard 10 extends only partially the width of the neck 6 in order to recess the joiner portion of a pattern template 4.

The pattern template 4 further comprises a semi-resilient planar sheet material having a thickness lesser than that of the space between the neck 6 and the fingerboard 10, and tabs 18 each lesser in width than the associated slot 8 between and below each fret.

Therefore, players utilizing the present invention are now able to learn hands—on both rudimentarily and auditorily at a skill level of the players choice, and speedily and easily interchange pattern templates when so desired, all without altering the feel of the instrument they grew to know.

What I claim as my invention:

1. An apparatus for learning to play a stringed instrument comprising:
a. a modified neck and fingerboard,
b. a transparent fingerboard,
c. at least one pattern template,
d. a method for modifying existing stringed instruments,

2. The apparatus for learning to play a stringed instrument of claim 1 wherein the instruments are musical instruments.

3. The apparatus for learning to play a stringed instrument of claim 1 wherein the fingerboard is freted.

4. The apparatus for learning to play a stringed instrument of claim 1 wherein the fingerboard is fretless.

5. The apparatus for learning to play a stringed instrument of claim 1 wherein the fingerboard is transparent.

6. The apparatus for learning to play a stringed instrument of claim 1 or 5 wherein the fingerboard is rigid.

7. The apparatus for learning to play a stringed instrument of claim 1 wherein the fingerboard has raised narrow portions thereof at every semitone interval thus creating a space therebetween for the insertion of a pattern template.

8. The apparatus for learning to play a stringed instrument of claim 1 wherein the fingerboard has raised narrow portions thereof at reasonable spans thus creating a wider space therebetween for the insertion of a pattern template.

9. The apparatus for learning to play a stringed instrument of claim 1 wherein the pattern template contains pre-printed chord patterns.

10. The apparatus for learning to play a stringed instrument of claim 1 wherein the pattern template contains pre-printed scale patterns.

11. The apparatus for learning to play a stringed instrument of claim 1, 8 or 9 wherein various symbols are used to define various patterns on one template.

12. The apparatus for learning to play a stringed instrument of claim 1 wherein the pattern template is blank.

13. The method for modifying a stringed instrument of claim 1 wherein the steps include:
1. removing the existing fingerboard,
2. preparing the neck surface for new fingerboard,
3. dry fitting the new fingerboard of the present invention,
4. making final trimming of the new fingerboard,
5. adhering and clamping the new fingerboard to the neck, and
6. finally trimming any burrs and adhesives from this work.

14. The method and apparatus for learning to play a stringed instrument of either claims 1 through 13 wherein the utility thereof allows speedier rudimentary and auditory skill acquisition of such stringed musical instruments.
